(19) United States
(12) Patent Application Publication
(10) Pub. No.: US 2019/0322451 A1
(43) Pub. Date: Oct. 24, 2019

(54) END OF ARM TOOL (EOAT) FOR BEVERAGE CARTONS

(71) Applicant: Bastian Solutions, LLC, Indianapolis, IN (US)

(72) Inventors: William A. Bastian, II, Carmel, IN (US); Joe G. Zoghzoghy, Dallas, TX (US); Thomas William Sharkey, Addison, TX (US); Todd Marshall Danner, Dallas, TX (US)

(73) Assignee: Bastian Solutions, LLC, Indianapolis, IN (US)

(21) Appl. No.: 16/386,843

(22) Filed: Apr. 17, 2019

Related U.S. Application Data
(60) Provisional application No. 62/659,371, filed on Apr. 18, 2018.

(51) Int. Cl. B65G 1/04; B65G 61/00; B65G 1/137; B65G 59/04; B65B 11/02

(52) U.S. Cl. CPC B65G 1/0435; B65G 61/00; B65G 1/1375; B65G 59/04; B65G 2203/0233; B65G 2201/025; B65G 2203/041; B65G 2203/042; B65B 11/025

(57) ABSTRACT

A beverage carton packing system includes an End of Arm Tool (EoAT). The EoAT is configured to lift one end and pull a beverage carton, package, or other container from a stack of cartons. Once pulled, the EoAT is configured to grab an opposite side of the carton and remove the carton from the stack. The EoAT is mounted to an Automated Guided Vehicle (AGV) via a robot arm. Through the EoAT, the robot arm is able to stack mixed pallets of the cartons on the AGV. The AGV has a funnel-shaped packing chamber where the mixed pallet is stacked and a stretch wrapper for stretch wrapping the mixed pallet.

### CROSS-REFERENCE TO RELATED APPLICATION

This application claims the benefit of U.S. Provisional Application No. 62/659,371 filed Apr. 18, 2018, which is hereby incorporated by reference.

### BACKGROUND

Handling beverages as well as other items can be a labor intensive process. With the spread of smaller stores, such as convenience and liquor stores, there has been a substantial increase in demand for “Mixed Stock Keeping Unit (SKU) Pallets” or mixed SKU orders in which a single pallet or order requires multiple different kinds of SKUs like different brands and/or types of beverages. For example, grocery stores, convenience stores, and/or liquor stores may not require an entire pallet of a particular brand of soft drink or beer but instead may require a mixed pallet containing different soft drink brands or other items. Consumers rarely order items in bulk such that their order typically contains a mix of SKUs. Processing mixed pallets or orders typically slows order fulfillment cycle times for shipping. These slow cycle times for both warehousing and shipping impact customer service levels as well as manufacturing efficiencies. The quicker that goods can be processed and loaded onto trucks, trains, ships, airplanes, drones, or other vehicles, the larger geographical area a distribution center, manufacturing plant, or warehouse can service. Mixed beverage orders make packing or stacking beverage carton and other packing more difficult. For instance, water bottles can be packed in plastic covered trays, and in contrast, cans are packed in boxes of varying dimensions. These differences in packaging sizes and shapes can cause packages to fall off the pallet during transport which makes handling more difficult. To handle these mixed orders with varying packaging sizes, shapes, weights, and materials, human labor is required which can be both a dangerous and expensive proposition.

Thus, there is a need for improvement in this field.

### SUMMARY

A palletizing mobile robot is designed to create mixed pallets for beverage packaging such as 24 packs of soft drink packs or 96 packs of water packs. The robot is mounted on an automated guided vehicle (AGV), and the AGV further includes a lift mechanism, such as a scissor lift, that is able to vertically move a pallet on which the beverage cartons are packed. Around the scissor lift is packing silo with a packing chamber that surrounds the lift mechanism along with the pallet that prevents the cartons from falling off of the pallet as the AGV moves. The chamber includes a flare at its opening that is proximal to the robot arm that is similar to a funnel in that the packed cartons are compressed together by the chamber as the pallet is lowered by the lift mechanism. Again, the chamber helps stabilize and tightly pack the cartons which is especially helpful for mixed pallets where different shaped and sized beverage cartons as well as other types of cartons are packed. The chamber includes a front door, such as a sliding door that allows the pallet to be slid off of the scissor lift through a conveyor. The AGV can further include a shrink or stretch wrapper at the top opening of the packing silo.

The EoAT includes a robot mount that in one form is horizontally mounted to the robot arm. In another example, the robot mount can be on the vertical side along the holding plate of the EoAT, but in that case, an extra motor may be added to improve the degree of motion as the wrist movement of the robotic arm is limited on the side mounting approach. In one form, the robot arm can turn at least 180 degrees relative to the AGV, and more specifically, the robot arm is able to turn at least around 300 degrees relative to the AGV so that the robot arm is able to access additional pallets. In one example, the robot mount supports a frame. A carriage is able to move horizontally along the frame. The carriage includes a lift motor that is operable to vertically move a push plate. Opposite the push plate, the EoAT has a holding plate that is fixed to the frame. A support plate is movably mounted to the holding plate. The support plate is able to move in a vertical direction along the holding plate when a package is picked. The support plate includes a plenum that provides vacuum (i.e., low pressure) to one or more vacuum cups. In one example, the holding plenum has three relatively large vacuum cups that are oriented in a triangular pattern. At the distal end of the plenum (i.e., during the picking position), the EoAT has three or more relatively smaller vacuum cups. The smaller vacuum cups are designed to pick up smaller items for packaging. The holding plate plenum in one example further includes a support plate that is able to grip underneath the packaging. Alternatively or additionally, fingers or paddles that are able to pivot and grip underneath the package are used in other variations.

Both the holding plate and the push plate have relatively thin profiles such that the EoAT can squeeze into and provide tight packing profiles of the cartons. The EoAT in one example is designed to pick up cases at least 60 pounds in weight, and the gripper between the holding plate and the push plate is able to provide gripping force to sufficiently hold the carton against the inertia when the EoAT is moved by the robot arm. In one form, the holding plate further includes a pressure plate so as to ensure that the push plate does not squeeze too hard against the package to cause rupturing. The robot arm and/or AGV includes a vision system, photo eye, distance sensors, and/or other types of sensors for sensing the position of the robot arm, AGV, and/or EoAT. In one example, the vision system is used to locate and/or orient the various cartons during the pick and/or pack procedure. The vision system is used to identify the good side of the cartons that are able to be gripped by the vacuum cups of the holding plate in one form. In another variation, alternatively or additionally, vacuum cups can be located so as to grip the top of the cartons. In one form, the EoAT and AGV are designed to pack with a 99.6% efficiency, that is without human intervention.

The robot uses a unique algorithm for packing or cubing cases to create a mixed pallet. The EoAT is designed to mimic how cases are normally picked and packed by an individual. Generally speaking, the EoAT is designed to approach the “good side” of the package via a vision system so that its vacuum cups are able to engage the packaging. The good side is defined by a surface that lacks openings that are able to facilitate vacuum cups being firmly secured to the individual side. Once the vacuum cups of the holding plate contact and establish a vacuum with one side, the EoAT pulls out and tilts up the package away from the stack. A bottom support flap is able to hook underneath the package so as to provide additional support. A push plate that provides high friction on the other end is lowered down and clamps on the end opposite of the vacuum cups and is squeezed against the packaging so as to grip the packaging.

During the picking operation, that is when a beverage carton or other package is being pulled from an already stored pallet of beverages, the AGV approaches the stack of beverages such that the robot arm is able via the EoAT to reach the desired beverage or other cart. To approach the carton, the lift motor via a rack and pinion-type motion raises the push plate so that it is out of the way. The vacuum or holding plate is then moved towards the appropriate end of the package that provides sufficient area for the vacuum cups to establish a vacuum. As noted before, the vision system is used such as in conjunction with artificial intelligence (AI) networks to determine the best approach for the EoAT. A vacuum is applied to the vacuum cups as it approaches the carton. Once these vacuum sensors sense the vacuum cups establishing a vacuum with the package (i.e., low pressure), the robot arm pulls on the EoAT such that the carton is slightly pulled from the pallet stack. Afterwards or at the same time, the holding plate vacuum plenum is raised slightly such as via a screw drive such that the carton is tilted. The support plate then is able to grab the edge of the carton facing the holding plate. At the same time or shortly thereafter, the carriage lowers the push plate into position so as to be able to engage the end of the carton that is opposite the holding plate once the push plate that has high-frictional material such as rubber, synthetic plastic, and the like is able to squeeze and contact the package to establish sufficient clamping force to hold the package in place. In other words the EoAT is able to squeeze the package between the push plate and the holding plate. Once properly secured, the EoAT or the robot arm is able to remove the carton from the stack and place it on the pallet that is located on the scissor lift on the AGV by generally taking the opposite approach.

Through the vision system, the AGV decides where to pack the carton based on the locations of other cartons on the pallet. The package gripped on the EoAT is moved generally to the appropriate location and slid on top of the carton in a tilted position. Once the end facing the pusher plate is supported by either the pallet or another package on the pallet, the grip of the push plate gripping force is removed and the push plate is raised such that the end of the beverage carton is able to be pushed against or propped against another package on the stack or in the appropriate location. The holding plenum on the holding plate can then be lowered as the holding plate pushes the package tightly against the other packages in the appropriate position. At the same time or before then, the support plate can either be folded out of the way in one form or remain in a stacked position. Once in the proper position, the vacuum can be removed such that the carton is released from the holding plate and the EoAT is moved out of the way via the robot arm so as to pick and/or place another package. The robot arm can continue the mixed pallet packing process via the EoAT when a full pack is established.

As individual layers of cartons are packed on the pallet, the scissor lift is lowered. The AGV can move to the requisite warehouse pallet of cartons or beverages to create the appropriate mixed pallet. As noted before, as the pallet is loaded, the chamber helps to further tightly pack the cartons on the pallet. Once the pallet is fully packed, the AGV can move to a particular discharge area such that the doors of the chamber can be opened and the pallet can be discharged via the roller conveyors or conveyor belt located on the scissor lift or via a forklift or in other manners. An empty pallet can then be loaded back onto the AGV and additional mixed pallets can be built via the palletizing AGV.

While the EoAT will be described for use with beverage cases, it should be recognized that the EoAT may handle a wide variety of products for packing together.

Aspect 1 generally concerns a system that includes an End of Arm Tool (EoAT) mimicking human container handling.

Aspect 2 generally concerns the system of aspect 1 in which the EoAT initially lifts and pulls the container and then grabs the other side.

Aspect 3 generally concerns the system of aspect 1 in which the EoAT has a gripper with a vertically movable vacuum cup plenum.

Aspect 4 generally concerns the system of aspect 3 in which the vacuum cup pattern includes the large cups arranged in a triangular pattern with small cups in a line below.

Aspect 5 generally concerns the system of aspect 3 in which the EoAT has a movable support plate for the gripper.

Aspect 6 generally concerns the system of aspect 3 in which the EoAT has foldable gripper fingers to grab the container corner.

Aspect 7 generally concerns the system of aspect 3 in which the EoAT has a plenum adjuster to move the plenum to tilt the container.

Aspect 8 generally concerns the system of aspect 3 in which the EoAT has a carriage lift motor to vertically move the push plate.

Aspect 9 generally concerns the system of aspect 8 in which the carriage lift motor uses a rack and pinion.

Aspect 10 generally concerns the system of aspect 8 in which the carriage is horizontally moveable to clamp the container with the push plate.

Aspect 11 generally concerns the system of aspect 1 in which the EoAT has a robot arm horizontal mount.

Aspect 12 generally concerns the system of aspect 1 in which the EoAT has a robot arm side mount.

Aspect 13 generally concerns the system of aspect 1 in which the EoAT robot arm is mounted to an Automated Guided Vehicle (AGV).

Aspect 14 generally concerns the system of aspect 13 in which the AGV has a lift mechanism.

Aspect 15 generally concerns the system of aspect 14 in which the lift mechanism includes a scissor lift.

Aspect 16 generally concerns the system of aspect 15 in which the lift mechanism includes a post screw scissor lift.

Aspect 17 generally concerns the system of aspect 14 in which the lift mechanism has a conveyor.

Aspect 18 generally concerns the system of aspect 14 in which the AGV has a packing chamber.

Aspect 19 generally concerns the system of aspect 18 in which the packing chamber has a funnel shape.

Aspect 20 generally concerns the system of aspect 18 in which the packing chamber has access doors.

Aspect 21 generally concerns the system of aspect 18 in which the orbital stretch wrapper is located at the chamber opening.

Aspect 22 generally concerns the system of aspect 1 in which the robot arm rotates at least 300 degrees relative to the AGV.

Aspect 23 generally concerns the system of aspect 1 in which the EoAT has a pressure plate for sensing squeezing force.

Aspect 24 generally concerns the system of aspect 1 in which the EoAT has a vision system for sensing container gripping.

Aspect 25 generally concerns the system of any previous aspect in which the EoAT initially lifts and pulls the container and then grabs the other side.

Aspect 26 generally concerns the system of any previous aspect in which the EoAT has a gripper with a vertically movable vacuum cup plenum.

Aspect 27 generally concerns the system of any previous aspect in which the vacuum cup pattern includes the large cups arranged in a triangular pattern with small cups in a line below.

Aspect 28 generally concerns the system of any previous aspect in which the EoAT has a movable support plate for the gripper.

Aspect 29 generally concerns the system of any previous aspect in which the EoAT has foldable gripper fingers to grab the container corner.

Aspect 30 generally concerns the system of any previous aspect in which the EoAT has a plenum adjuster to move the plenum to tilt the container.

Aspect 31 generally concerns the system of any previous aspect in which the EoAT has a carriage lift motor to vertically move the push plate.

Aspect 32 generally concerns the system of any previous aspect in which the carriage lift motor uses a rack and pinion.

Aspect 33 generally concerns the system of any previous aspect in which the carriage is horizontally moveable to clamp the container with the push plate.

Aspect 34 generally concerns the system of any previous aspect in which the EoAT has a robot arm horizontal mount.

Aspect 35 generally concerns the system of any previous aspect in which the EoAT has a robot arm side mount.

Aspect 36 generally concerns the system of any previous aspect in which the EoAT robot arm is mounted to an Automated Guided Vehicle (AGV).

Aspect 37 generally concerns the system of any previous aspect in which the AGV has a lift mechanism.

Aspect 38 generally concerns the system of any previous aspect in which the lift mechanism includes a scissor lift.

Aspect 39 generally concerns the system of any previous aspect in which the lift mechanism includes a post screw scissor lift.

Aspect 40 generally concerns the system of any previous aspect in which the lift mechanism has a conveyor.

Aspect 41 generally concerns the system of any previous aspect in which the AGV has a packing chamber.

Aspect 42 generally concerns the system of any previous aspect in which the packing chamber has a funnel shape.

Aspect 43 generally concerns the system of any previous aspect in which the packing chamber has access doors.

Aspect 44 generally concerns the system of any previous aspect in which the orbital stretch wrapper is located at the chamber opening.

Aspect 45 generally concerns the system of any previous aspect in which the robot arm rotates at least 300 degrees relative to the AGV.

Aspect 46 generally concerns the system of any previous aspect in which the EoAT has a pressure plate for sensing squeezing force.

Aspect 47 generally concerns the system of any previous aspect in which the EoAT has a vision system for sensing container gripping.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a perspective view of a container handling system.

FIG. 2 is a perspective view of a first example of a beverage carton End of Arm Tool (EoAT) used in the FIG. 1 system.

FIG. 3 is a front perspective view of a second example of a beverage carton EoAT used in the FIG. 1 system.

FIG. 4 is a rear perspective view of the FIG. 3 EoAT.

FIG. 5 is a front perspective view of a push plate actuator found in the FIG. 3 EoAT.

FIG. 6 is a rear perspective view of the FIG. 5 push plate actuator.

FIG. 7 is a front perspective view of a plenum and paddle assembly found in the FIG. 3 EoAT.

FIG. 8 is a rear perspective view of the FIG. 7 plenum and paddle assembly.

FIG. 9 is a perspective view of a third example of a beverage carton EoAT used in the FIG. 1 system.

FIG. 10 is a first side view of the FIG. 9 EoAT.

FIG. 11 is a second side view of the FIG. 9 EoAT.

FIG. 12 is a front view of the FIG. 9 EoAT.

FIG. 13 is a rear view of the FIG. 9 EoAT.

FIG. 14 is a top view of the FIG. 9 EoAT.

FIG. 15 is a bottom view of the FIG. 9 EoAT.

FIG. 16 is a rear perspective view of the FIG. 9 EoAT with selected components removed.

FIG. 17 is an enlarged perspective view of a plenum and paddle assembly in the FIG. 9 EoAT with selected components removed.

FIG. 18 is an enlarged perspective view of a plenum in the FIG. 17 assembly.

FIG. 19 is a wire-frame view of the FIG. 18 plenum.

FIG. 20 is a top perspective view of the FIG. 9 EoAT with selected components removed.

FIG. 21 is an enlarged perspective view of a push plate actuator in the FIG. 9 EoAT with selected components removed.

FIG. 22 is an enlarged perspective view of the FIG. 21 push plate actuator with selected components removed.

FIG. 23 is a perspective view of the FIG. 2 EoAT approaching a carton.

FIG. 24 is a perspective view of the FIG. 2 EoAT picking and tilting the carton.

FIG. 25 is a perspective view of the FIG. 2 EoAT securing the carton.

FIG. 26 is a perspective view of a beverage container handling system with an Automated Guided Vehicle according to another example.

FIG. 27 is an enlarged perspective view of the FIG. 26 Automated Guided Vehicle with selected components removed.

FIG. 28 is a side view of the FIG. 26 Automated Guided Vehicle with selected components removed.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

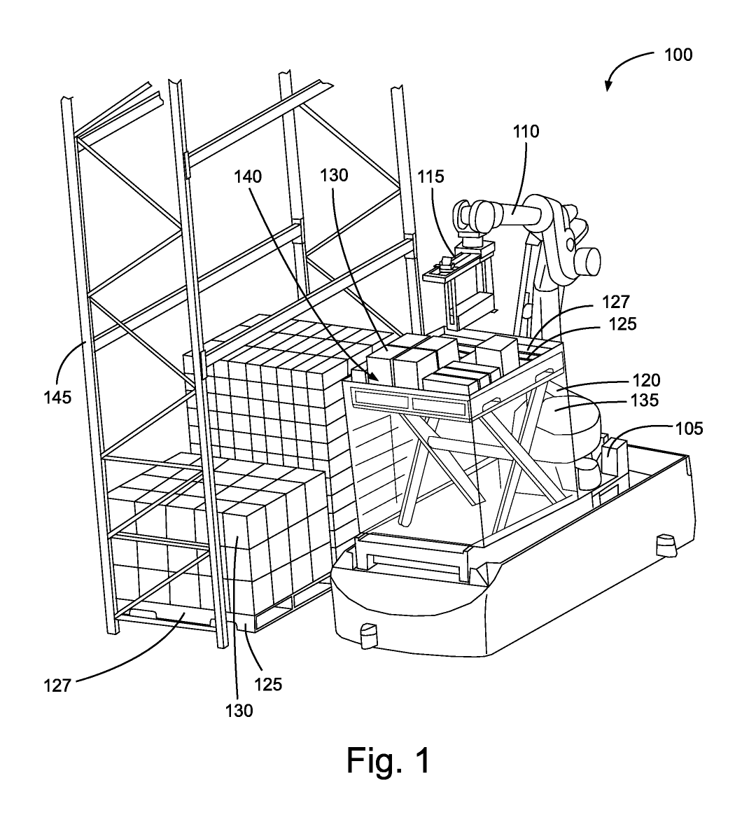

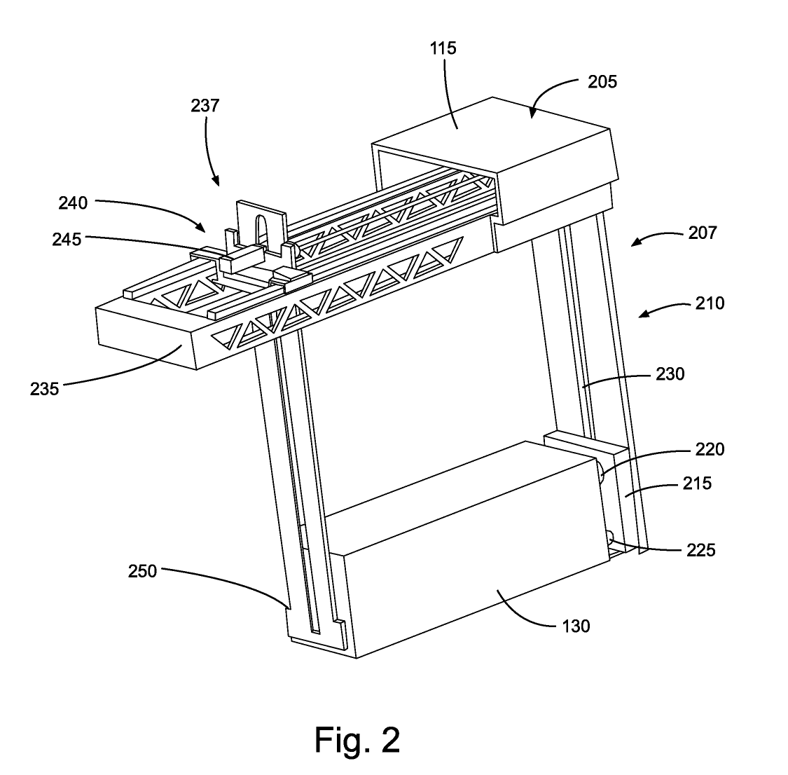

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

FIG. 1 show a perspective view of a beverage container handling system 100. The beverage container handling system 100 includes an Automated Guided Vehicle 105 (AGV) with a robot arm 110. The robot arm 110 has an End of Arm Tool 115 (EoAT). The Automated Guided Vehicle 105 further includes a lift mechanism 120 for supporting a transport structure 125 which in the depicted example is a pallet 127. In the illustrated example, the pallet 127 is configured to support one or more containers 130, such as beverage cartons or water bottle packs. Surrounding the lift mechanism 120, the Automated Guided Vehicle 105 has a packing silo 135 that defines a packing chamber 140. In one example, the packing silo 135 facing the packing chamber 140 has a low friction surface to enhance packing. For instance, the inner surface of the packing silo 135 is formed, coated, or otherwise covered with an Ultra-high-molecular-weight polyethylene (UHMW) material. The robot arm 110 is able to transfer containers 130 between the transport structure 125 on the lift mechanism 120 and the transport structure 125 at a storage unit 145. The packing silo 135 includes a flare at its opening that is proximal to the robot arm 110 that is similar to a funnel in that the packed containers 130 are compressed together by the packing silo 135 as the transport structure 125 is lowered by the lift mechanism 120. Again, the packing chamber 140 helps stabilize and tightly pack the containers 130 which is especially helpful for mixed pallets where different shaped and sized beverage cartons as well as other types of packaging (e.g., water bottle trays) are packed. The packing silo 135 includes a front door, such as a sliding door that allows the pallet 127 to be slid off of the lift mechanism 120 through a conveyor. The Automated Guided Vehicle 105 can further include a shrink or stretch wrapper at the top opening of the packing silo 135.

Turning to FIG. 2, the End of Arm Tool 115 includes a robot mount 205 where the robot arm 110 is attached to the End of Arm Tool 115. In the illustrated example, the End of Arm Tool 115 includes robot mount 205 is horizontal type. In another example, the robot mount 205 is a vertical type mount that is mounted along a vertical side of the robot mount 205, but in that case, an extra motor may be added to improve the degree of motion as the wrist movement of the robot arm 110 is limited on the side mounting approach. The End of Arm Tool 115 further includes a plenum and paddle assembly 207. As shown, the plenum and paddle assembly 207 includes a holding plate 210, a plenum 215, one or more vacuum cups 220, a support plate 225, and a plenum adjuster 230 for adjusting the vertical location of the plenum 215 relative to the holding plate 210. The plenum 215 provides vacuum (i.e., low pressure) to the vacuum cups 220. In one example, the plenum 215 has at least three relatively large vacuum cups 220 that are oriented in a triangular pattern. At the distal end of the plenum and paddle assembly 207 (i.e., during the picking position), the End of Arm Tool 115 has four or more smaller vacuum cups 220. The smaller vacuum cups 220 are designed to pick up smaller containers 130 for packing. The support plate 225 is able to pivot vertically to grip underneath the containers 130. Alternatively or additionally, fingers or paddles that are able to pivot horizontally and grip underneath the containers 130 are used in other variations described below. The support plate 225 is able to move in a vertical direction along with the plenum 215 when one of the containers 130 is picked. In the illustrated example, the robot mount 205 supports the plenum and paddle assembly 207 and a frame 235. The frame 235 includes a push plate actuator 237, and the push plate actuator 237 has a carriage 240. The carriage 240 is able to move horizontally along with the frame 235. The carriage 240 includes a lift motor 245 that is operable to vertically move a push plate 250. Opposite the push plate 250, the End of Arm Tool 115 has the holding plate 210 that is fixed to the frame 235. The carriage 240 causes the push plate 250 to press the containers 130 against the vacuum cups 220 of the holding plate 210.

Both the holding plate 210 and the push plate 250 have relatively thin profiles such that the End of Arm Tool 115 can squeeze in between and provide tight packing profiles of cartons or other packages. The End of Arm Tool 115 in one example is designed to pick up cases at least 60 pounds in weight. The gripper formed between the holding plate 210 and the push plate 250 is able to provide gripping force to sufficiently hold the containers 130 against the inertia when the End of Arm Tool 115 is moved by the robot arm 110. In one form, the holding plate 210 further includes a pressure plate so as to ensure that the push plate 250 does not squeeze too hard against the containers 130 to cause rupturing. The beverage container handling system 100, Automated Guided Vehicle 105, robot arm 110, and/or End of Arm Tool 115 includes a vision system, photo eye, distance sensors, and/or other types of sensors for sensing the position of the beverage container handling system 100, Automated Guided Vehicle 105, robot arm 110, and/or End of Arm Tool 115. In one example, the vision system is used to locate and/orient the various packages during the pick and/or pack procedure. The vision system is used to identify the good sides of the containers 130 that are able to be gripped by the vacuum cups 220 of the holding plate 210 in one form. In another variation, alternatively or additionally, the vacuum cups 220 can be located so as to grip the tops of the containers 130. In one form, the Automated Guided Vehicle 105 and End of Arm Tool 115 are designed to pack with a 99.6% efficiency, that is without human intervention.

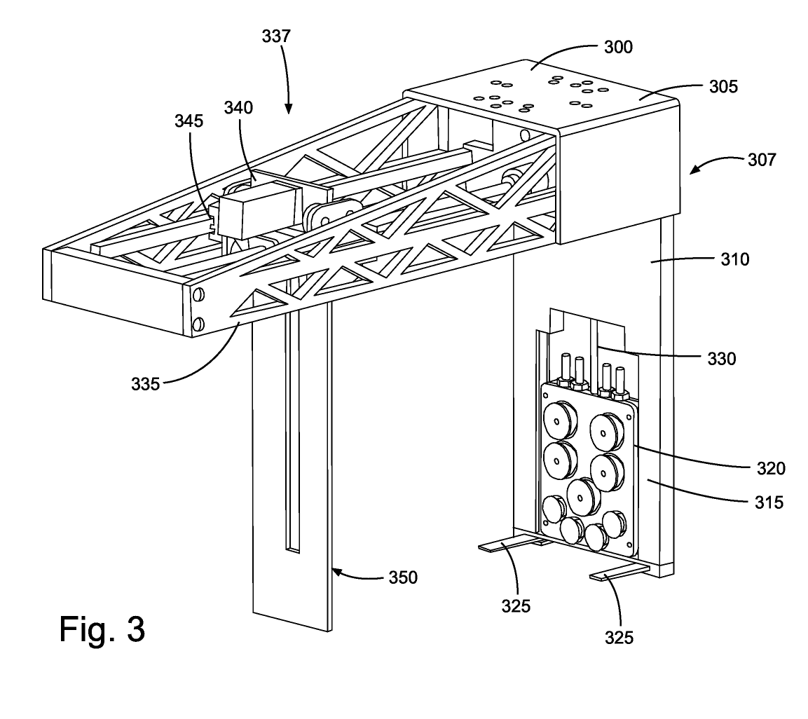

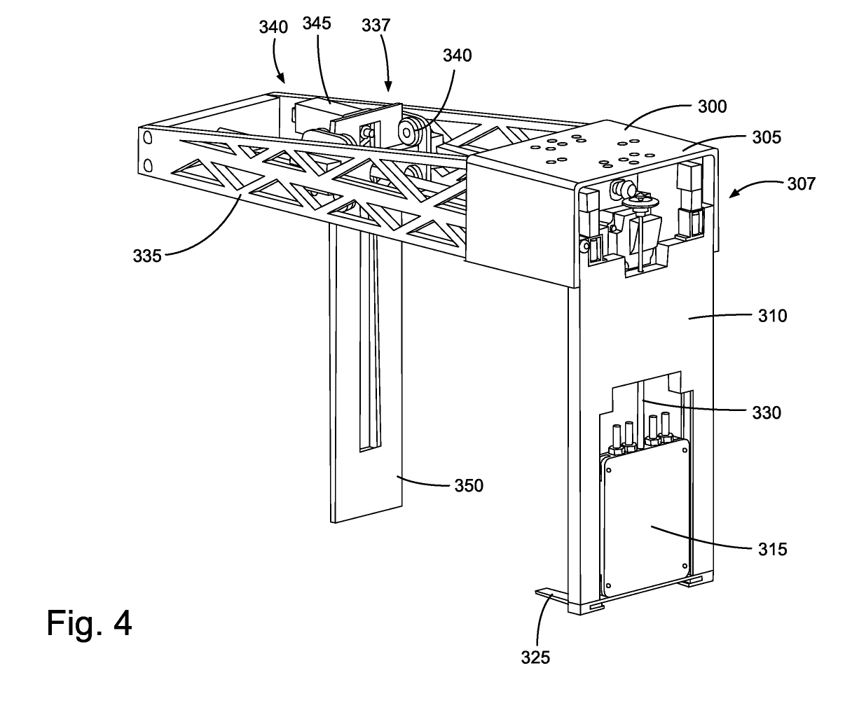

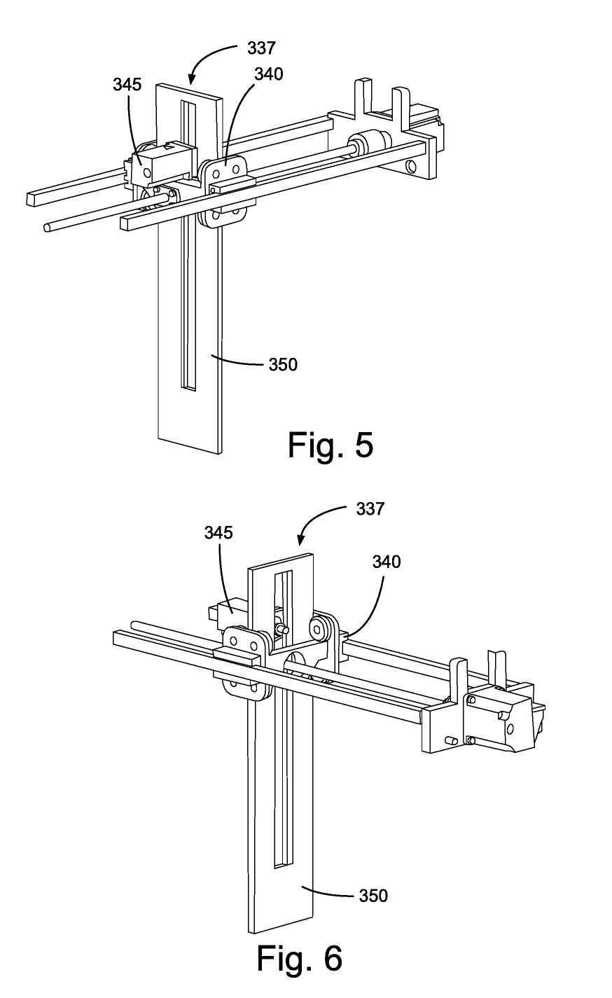

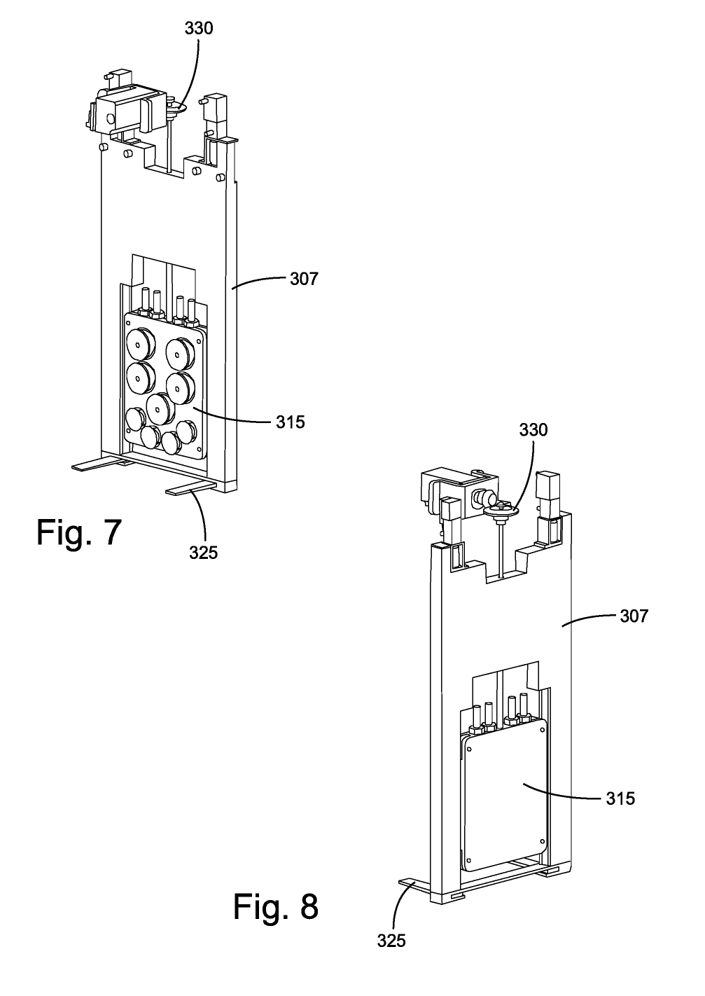

FIGS. 3-8 illustrate another example of an End of Arm Tool 300 that can be attached to the robot arm 110 of the Automated Guided Vehicle 105. As shown, the End of Arm Tool 300 includes a robot mount 305 where the robot arm 110 is attached to the End of Arm Tool 300. In the illustrated example, the End of Arm Tool 300 includes robot mount 305 that is a horizontal type mount. In another example, the robot mount 305 is a vertical type mount that is mounted along a vertical side of the robot mount 305, but in that case, an extra motor may be added to improve the degree of motion as the wrist movement of the robot arm 110 is limited on the side mounting approach. The End of Arm Tool 300 further includes a plenum and paddle assembly 307. As shown, the plenum and paddle assembly 307 includes a holding plate 310, a plenum 315, one or more vacuum cups 320, one or more support fingers 325 (paddles), and a plenum adjuster 330 for adjusting the vertical location of the plenum 315 relative to the holding plate 310. The plenum 315 provides vacuum (i.e., low pressure) to vacuum cups 320. In one example, the plenum 315 has at least three relatively large vacuum cups 320 that are oriented in a triangular pattern. At the distal end of the plenum and paddle assembly 307 (i.e., during the picking position), the End of Arm Tool 300 has four or more relatively smaller vacuum cups 320. The smaller vacuum cups 320 are designed to pick up smaller containers 130 for packing. The support fingers 325 is able to rotate or pivot horizontally to grip underneath the containers 130. The support fingers 325 is able to move in a vertical direction along with the plenum 315 when one of the containers 130 is picked. In the illustrated example, the robot mount 305 supports the plenum and paddle assembly 307 and a frame 335. The frame 335 includes a push plate actuator 337, and the push plate actuator 337 has a carriage 340. The carriage 340 is able to move horizontally relative to the holding plate 310. The carriage 340 includes a lift motor 345 that is operable to vertically move a push plate 350. Opposite the push plate 350, the End of Arm Tool 300 has the holding plate 310 that is fixed to the frame 335. The carriage 340 causes the push plate 350 to press the containers 130 against the vacuum cups 320 of the holding plate 310. The plenum adjuster 330 is used to raise the plenum 315 which in turn tilts the containers 130 when secured with the vacuum cups 320.

Both the holding plate 310 and the push plate 350 have relatively thin profiles such that the End of Arm Tool 300 can squeeze in between and provide tight packing profiles of cartons or other packages. The End of Arm Tool 300 in one example is designed to pick up cases at least 60 pounds in weight. The gripper formed between the holding plate 310 and the push plate 350 is able to provide gripping force to sufficiently hold the containers 130 against the inertia when the End of Arm Tool 300 is moved by the robot arm 110. In one form, the holding plate 310 further includes a pressure plate so as to ensure that the push plate 350 does not squeeze too hard against the containers 130 to cause rupturing. The beverage container handling system 100, Automated Guided Vehicle 105, robot arm 110, and/or End of Arm Tool 300 includes a vision system, photo eye, distance sensors, and/or other types of sensors for sensing the position of the beverage container handling system 100, Automated Guided Vehicle 105, robot arm 110, and/or End of Arm Tool 300. In one example, the vision system is used to locate and/orient the various packages during the pick and/or pack procedure. The vision system is used to identify the good sides of the containers 130 that are able to be gripped by the vacuum cups 320 of the holding plate 310 in one form. In another variation, alternatively or additionally, the vacuum cups 320 can be located so as to grip the tops of the containers 130. In one form, the Automated Guided Vehicle 105 and End of Arm Tool 300 are designed to pack with a 99.6% efficiency, that is without human intervention.

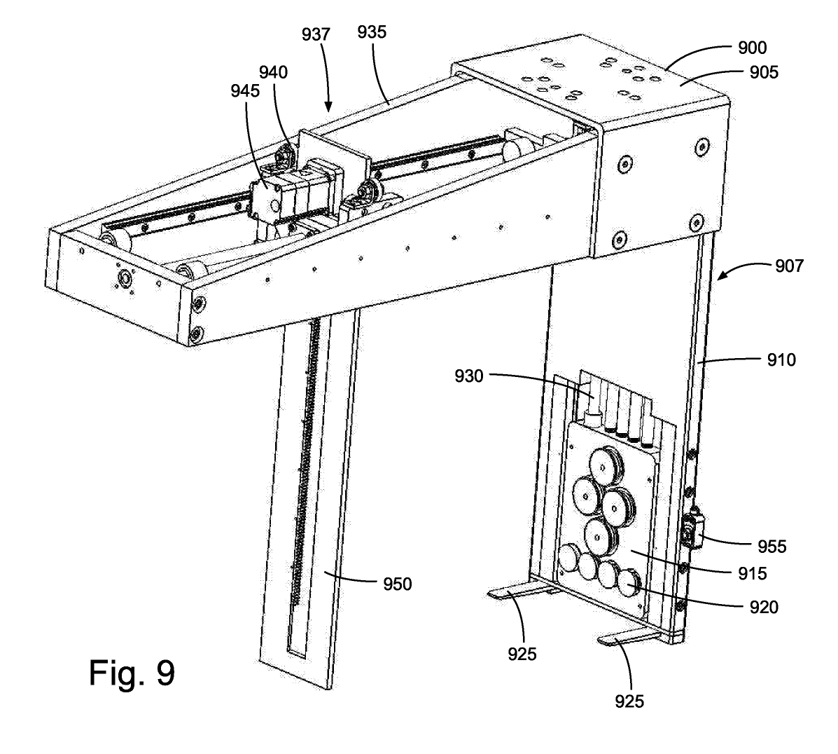

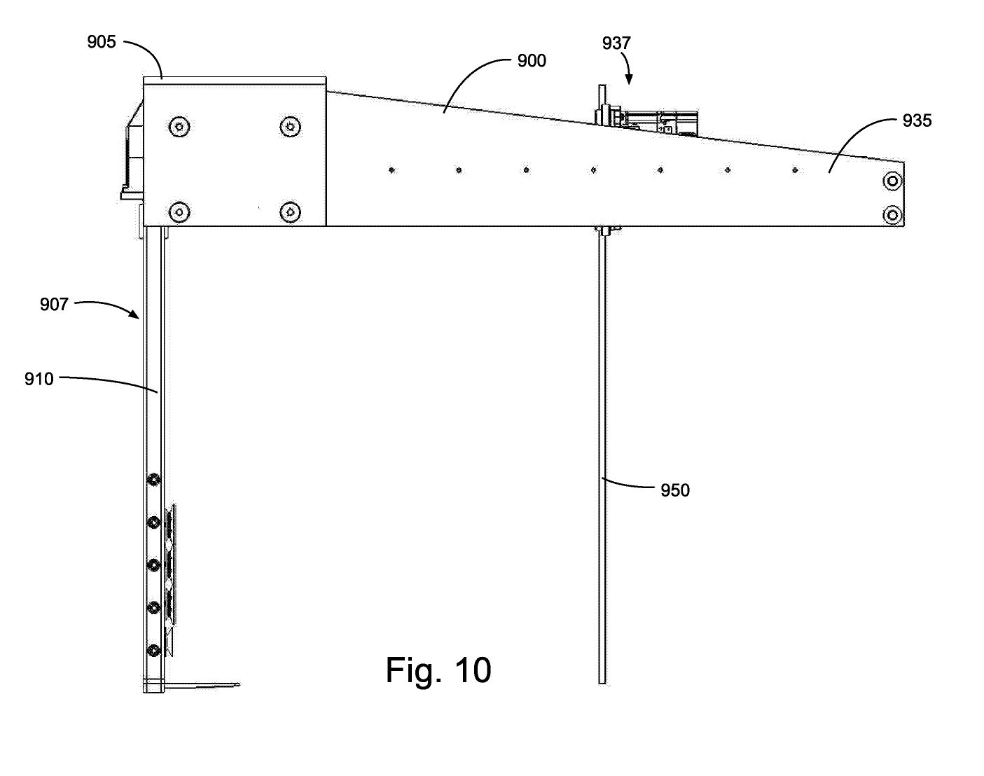

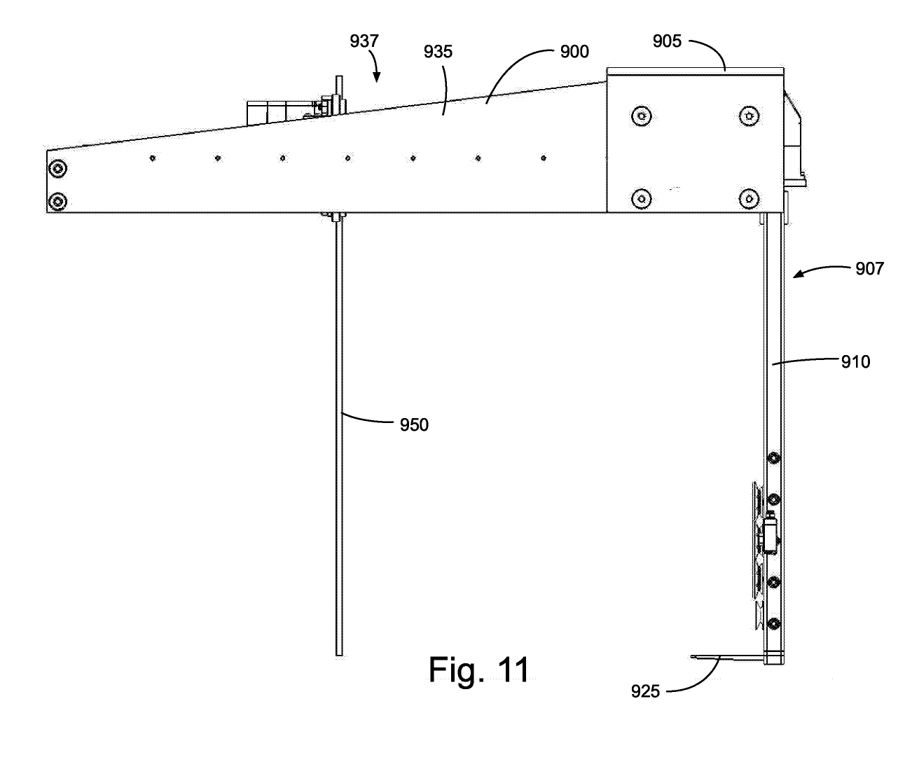

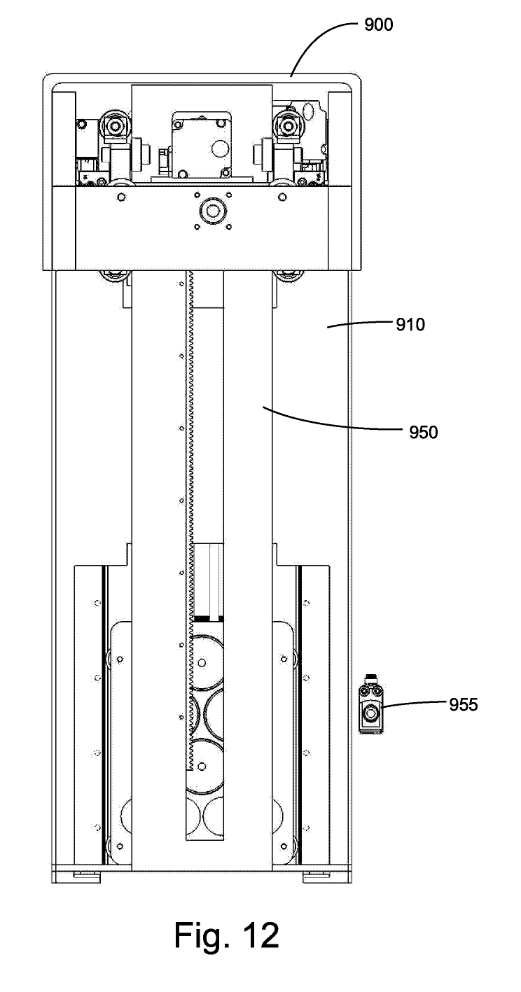

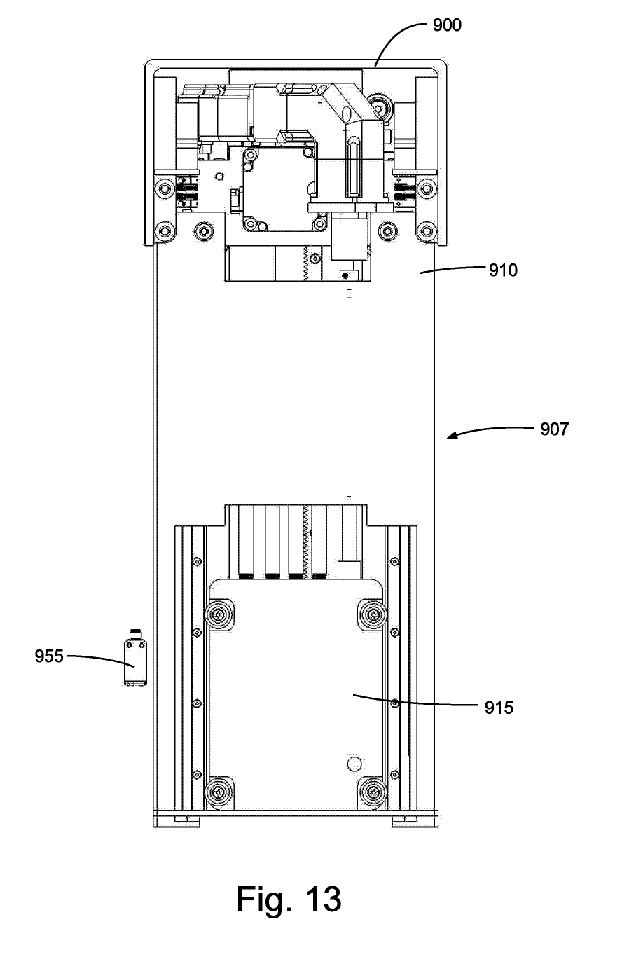

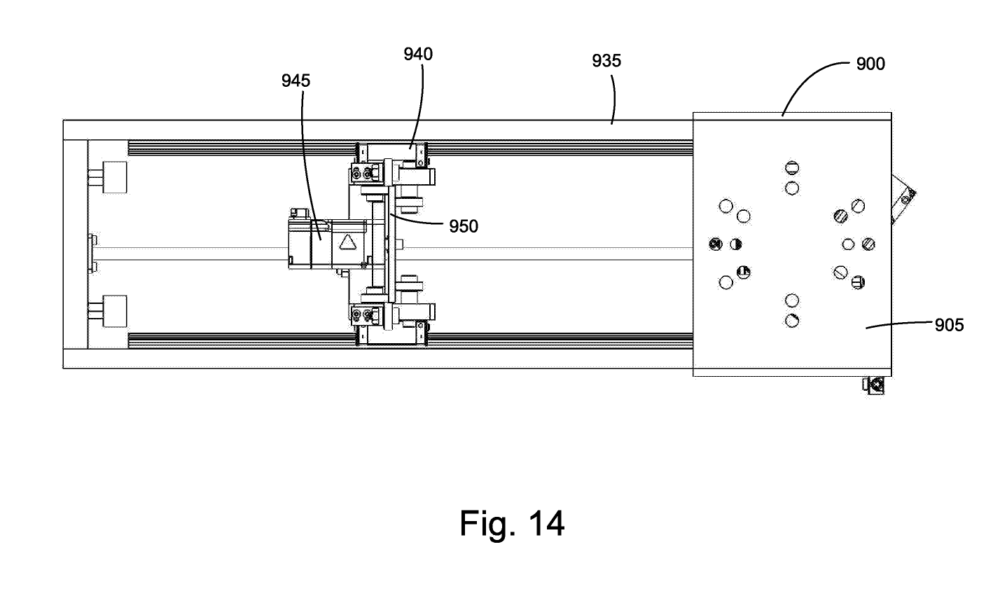

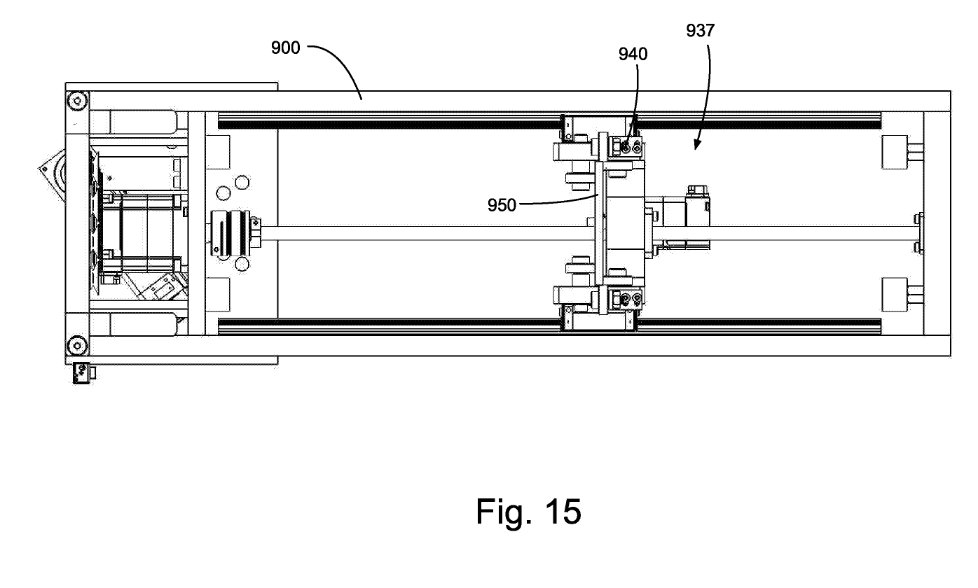

FIGS. 9-22 illustrate a further example of an End of Arm Tool 900 that can be attached to the robot arm 110 of the Automated Guided Vehicle 105. As shown, the End of Arm Tool 900 includes a robot mount 905 where the robot arm 110 is attached to the End of Arm Tool 900. In the illustrated example, the robot mount 905 is a horizontal mount type. In another example, the robot mount 905 is a vertical type mount that is mounted along a vertical side of the robot mount 905, but in that case, an extra motor may be added to improve the degree of motion as the wrist movement of the robot arm 110 is limited on the side mounting approach. The End of Arm Tool 900 further includes a plenum and paddle assembly 907.

As shown, the plenum and paddle assembly 907 includes a holding plate 910, a plenum 915, one or more vacuum cups 920, one or more support fingers 925 (paddles), and a plenum adjuster 930 for adjusting the vertical location of the plenum 915 relative to the holding plate 910. The plenum 915 provides vacuum (i.e., low pressure) to vacuum cups 920. In one example, the plenum 915 has at least three relatively large vacuum cups 920 that are oriented in a triangular pattern. At the distal end of the plenum and paddle assembly 907 (i.e., during the picking position), the End of Arm Tool 900 has four or more smaller vacuum cups 920. The smaller vacuum cups 920 are designed to pick up smaller containers 130 for packing. The support fingers 925 are able to rotate or pivot horizontally to grip underneath the containers 130. The support fingers 925 are able to move in a vertical direction along with the plenum 915 when one of the containers 130 is picked. In the illustrated example, the robot mount 905 supports the plenum and paddle assembly 907 and a frame 935. The frame 935 includes a push plate actuator 937, and the push plate actuator 937 has a carriage 940. The carriage 940 is able to move horizontally relative to the holding plate 910. The carriage 940 includes a lift motor 945 that is operable to vertically move a push plate 950. Opposite the push plate 950, the End of Arm Tool 900 has the holding plate 910 that is fixed to the frame 935. The carriage 940 causes the push plate 950 to press the containers 130 against the vacuum cups 920 of the holding plate 910. The plenum adjuster 930 is used to raise the plenum 915 which in turn tilts the containers 130 when secured with the vacuum cups 920.

Both the holding plate 910 and the push plate 950 have relatively thin profiles such that the End of Arm Tool 900 can squeeze in between and provide tight packing profiles of cartons or other packages. The End of Arm Tool 900 in one example is designed to pick up cases at least 60 pounds in weight. The gripper formed between the holding plate 910 and the push plate 950 is able to provide gripping force to sufficiently hold the containers 130 against the inertia when the End of Arm Tool 900 is moved by the robot arm 110. In one form, the holding plate 910 further includes a pressure plate so as to ensure that the push plate 950 does not squeeze too hard against the containers 130 to cause rupturing. The beverage container handling system 100, Automated Guided Vehicle 105, robot arm 110, and/or End of Arm Tool 900 includes a vision system, photo eye, distance sensors, and/or other type of sensor 955 for sensing the position of the beverage container handling system 100, Automated Guided Vehicle 105, robot arm 110, and/or End of Arm Tool 900. In one example, the sensor 955 on the End of Arm Tool 900 is used to locate and/orient the various packages during the pick and/or pack procedure. The sensor 955 is used to identify the good sides of the containers 130 that are able to be gripped by the vacuum cups 920 of the holding plate 910 in one form. In another variation, alternatively or additionally, vacuum cups 920 can be located so as to grip the tops of the containers 130. In one form, the End of Arm Tool 900 and Automated Guided Vehicle 105 are designed to pack with a 99.6% efficiency.

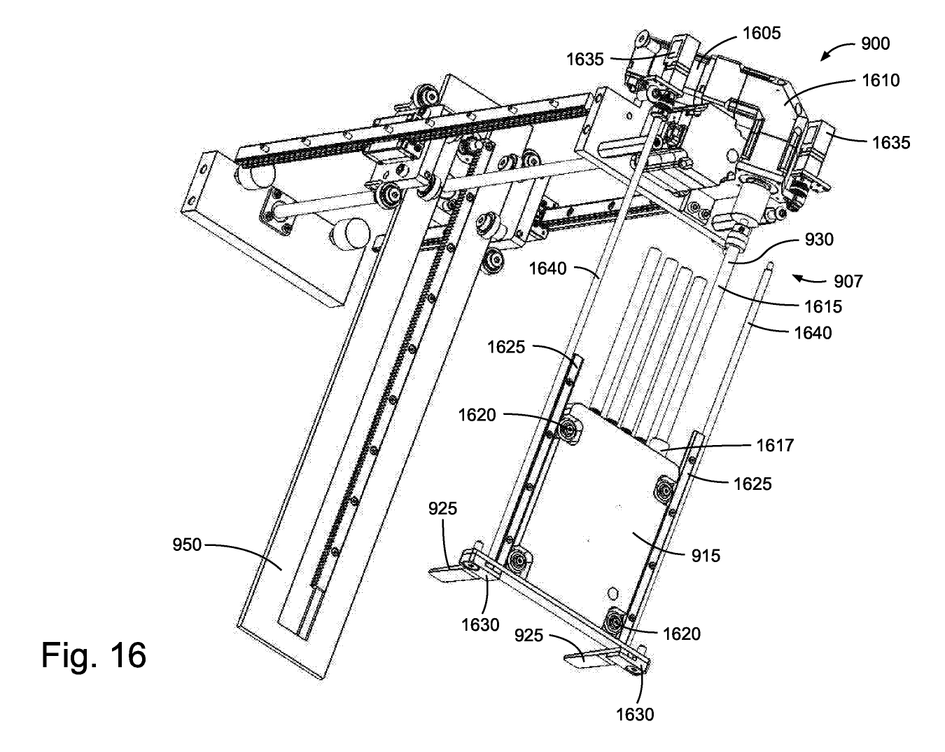

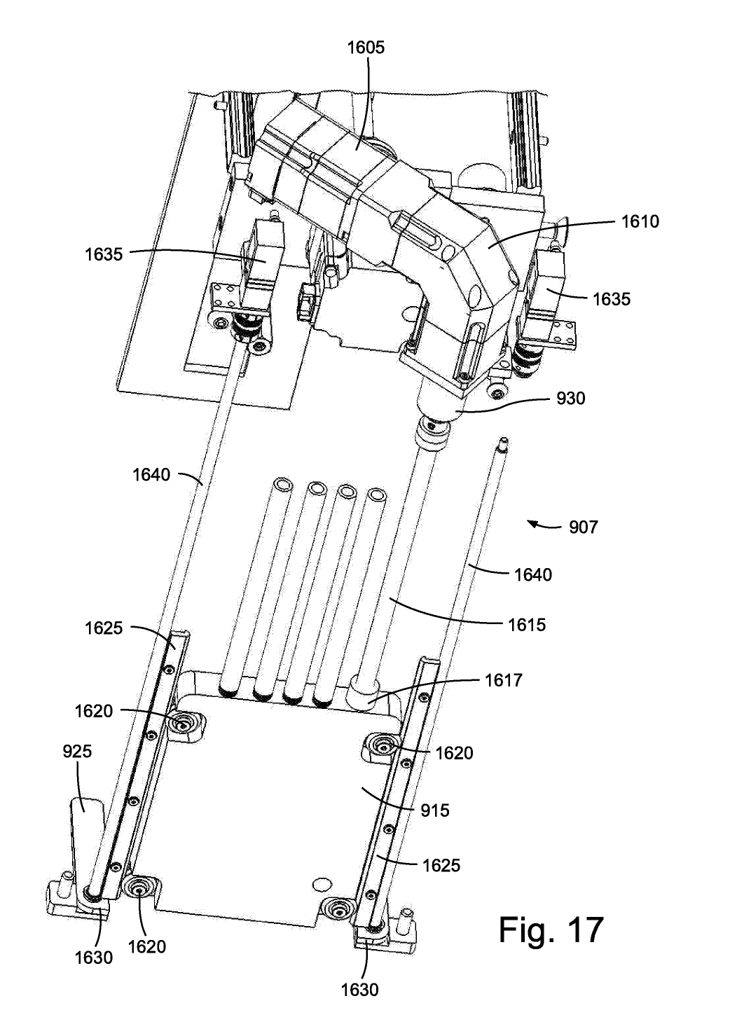

FIGS. 16 and 17 illustrate the End of Arm Tool 900 with selected components removed to increase visibility on selected internal components. As shown, the plenum adjuster 930 of the plenum and paddle assembly 907 includes a plenum adjuster motor 1605, a gearbox 1610 coupled to the plenum adjuster motor 1605, a drive shaft 1615 extending from the gearbox 1610, and a drive shaft coupler 1617 secured to the plenum 915. In one example, the drive shaft 1615 is secured to the drive shaft coupler 1617 through a threaded connection such that the plenum adjuster motor 1605 is able to raise or lower the plenum 915 by rotation of the drive shaft 1615. The plenum 915 has one or more guide wheels 1620 that ride along one or more guide rails 1625 when the plenum 915 is vertically moved in order to tilt (or lower) the ends of the containers 130. The plenum and paddle assembly 907 further includes one or more hinge 1630 to which the support fingers 925 are pivotally secured. The support fingers 925 are able to pivot horizontally at least 90 degrees relative to the holding plate 910 such that they are able to be stowed by being tucked under the plenum 915 and deployed by pivoting horizontally to positions where the support fingers 925 extend generally perpendicular to the plenum 915. To rotate the support fingers 925, the plenum and paddle assembly 907 includes one or more finger motors 1635 with each having an actuator shaft 1640 that connects each of the support fingers 925 to their respective finger motors 1635. Through the actuator shaft 1640, the finger motors 1635 are able to rotate the support fingers 925.

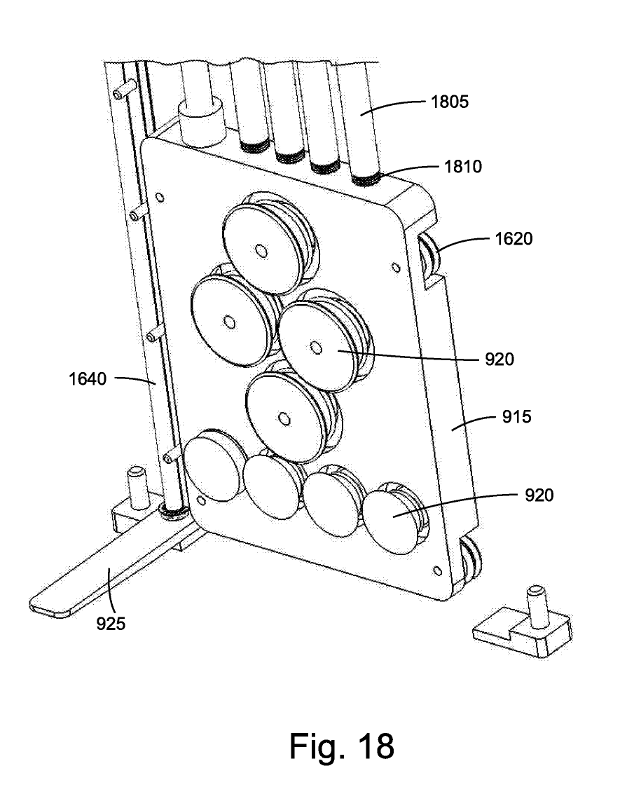

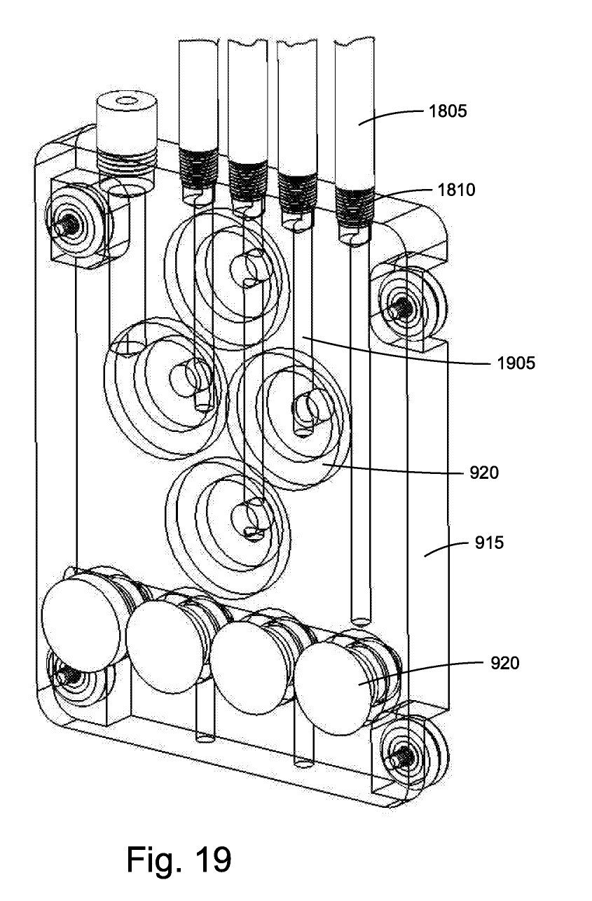

Turning to FIG. 18, a vacuum or low pressure is supplied to the vacuum cups 920 of the plenum 915 via one or more vacuum hoses 1805. The vacuum hoses 1805 are connected to the plenum 915 at one or more vacuum ports 1810. As can be seen in FIG. 19, the vacuum hoses 1805 are connected to the vacuum cups 920 through one or more vacuum passages 1905 in the plenum 915.

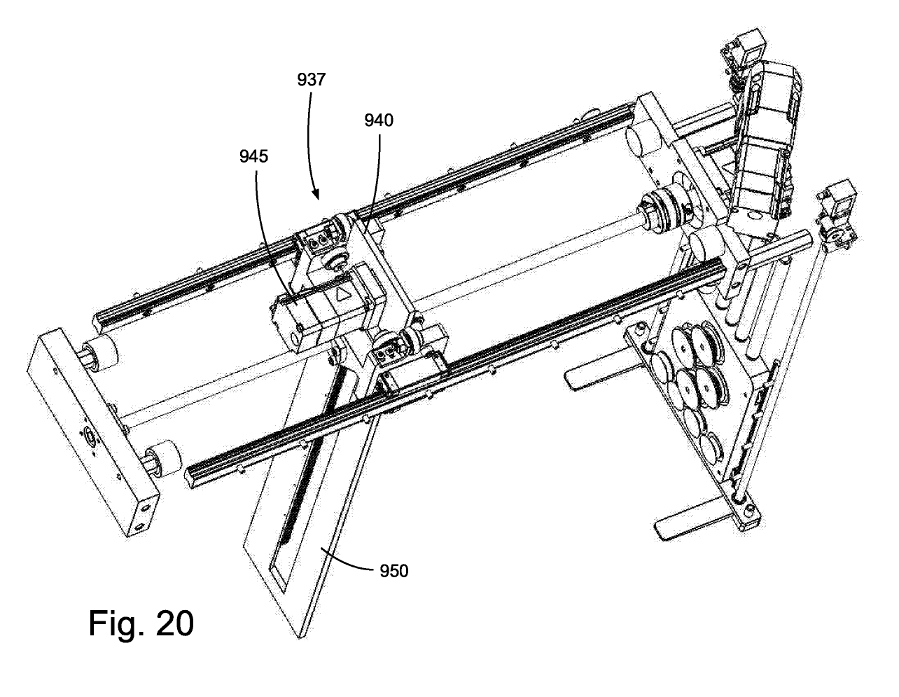

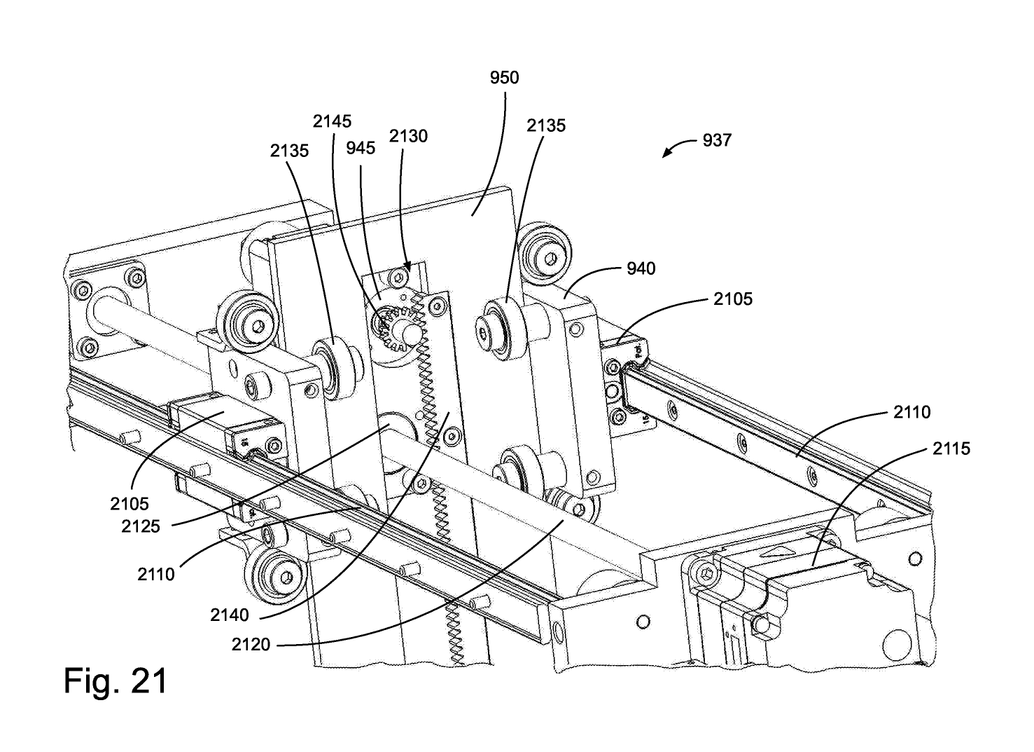

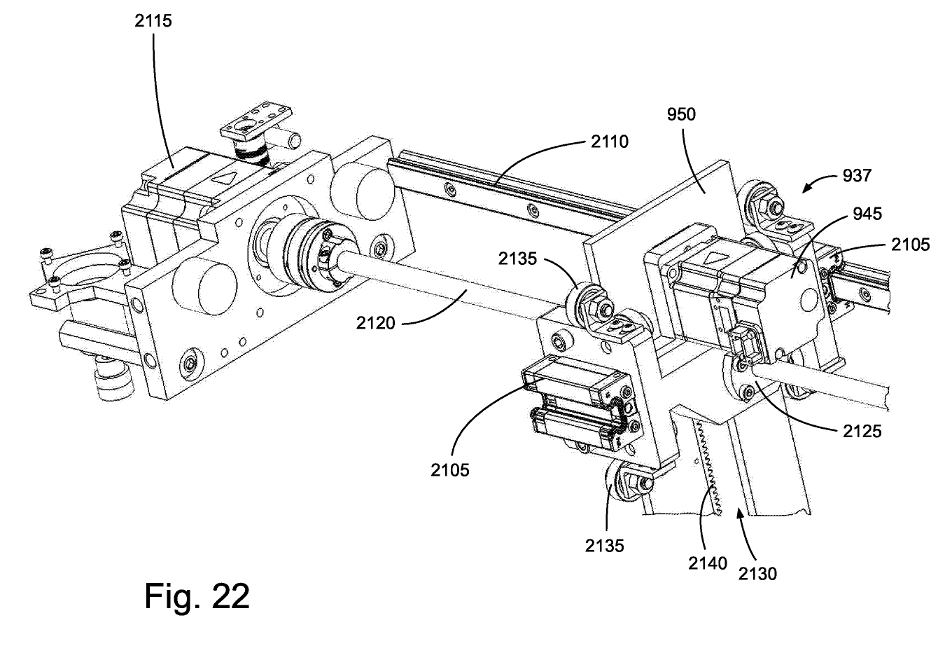

Referring to FIGS. 20-22, the push plate actuator 937 has the carriage 940 and the lift motor 245 that respectively move the push plate 950 in horizontal (clamping) and vertical (deploying) directions. As shown in FIGS. 21 and 22, the carriage 940 has one or more carriage bearings 2105 that ride along one or more carriage rails 2110. The carriage rails 2110 are secured to the frame 935. A carriage motor 2115 is coupled to the carriage 940 through a carriage actuator shaft 2120. The carriage actuator shaft 2120 is coupled to the carriage 940 through a carriage shaft coupler 2125. In one variation, the carriage actuator shaft 2120 and carriage shaft coupler 2125 are threadedly engaged such that when the carriage motor 2115 rotates the carriage actuator shaft 2120, the carriage 940 moves horizontally along the carriage rails 2110. As illustrated, the carriage actuator shaft 2120 extends through a push plate slot 2130 in the push plate 950. The carriage 940 has one or more guide bearings 2135 that facilitate smooth vertical movement of the push plate 950 relative to the carriage 940. Inside the push plate slot 2130, the push plate 950 has a rack 2140 that engages a pinion 2145 that is coupled to the lift motor 945.

The lift motor 945 is able to raise and lower the push plate 950 by rotating the pinion 2145.

Below are some example engineering specifications that can be used for one or more of the components of the EoATs 115, 300, 900 described above:

Push Plate Specs (Horizontal Movement): Actuation method: servomotor with ball screw Actuation force: 60 lbs Range of motion: 17 in Max speed: 37.5 in/sec Motor: Yaskawa SGM7A-02A (200 W) Ball screw: Thomson Linear −10 mm OD×10 mm lead

Push Plate Specs (Vertical Movement): Actuation method: servomotor with rack and pinion Actuation force: 10 lbs Range of motion: 13 in Max speed: 100 in/sec (˜0.25 seconds to raise or lower) Motor: Yaskawa SGM7A-01A (100 W) Rack and pinion: Berg −1 mm Pitch Plenum Specs (Vertical Movement): Actuation method: servomotor with bevel gear and lead screw Actuation force: 35 lbs Range of motion: 2 in Max speed: 11.4 in/sec (−0.35 seconds to raise or lower) Motor: Yaskawa SGM7A-01A (100 W) Bevel gear: Berg 2:1 Lead screw: Thomson Linear −0.25″ OD×0.25″ lead

Plenum Specs (Pneumatics): Large suction cups: Piab B35XP.4K (5×) Large suction cup shear force lifting capability: 9 lbs Small suction cups: Piab B25XP.4K (4×) Small suction cup shear force lifting capability: 3.37 lbs

Fingers/Paddles: Actuation method: servomotors Actuation torque: 0.01 Nm Range of motion: 90 degrees Max speed: 720 degrees/sec (˜0.25 seconds actuation time) Motor: Yaskawa SGMMV-B3E

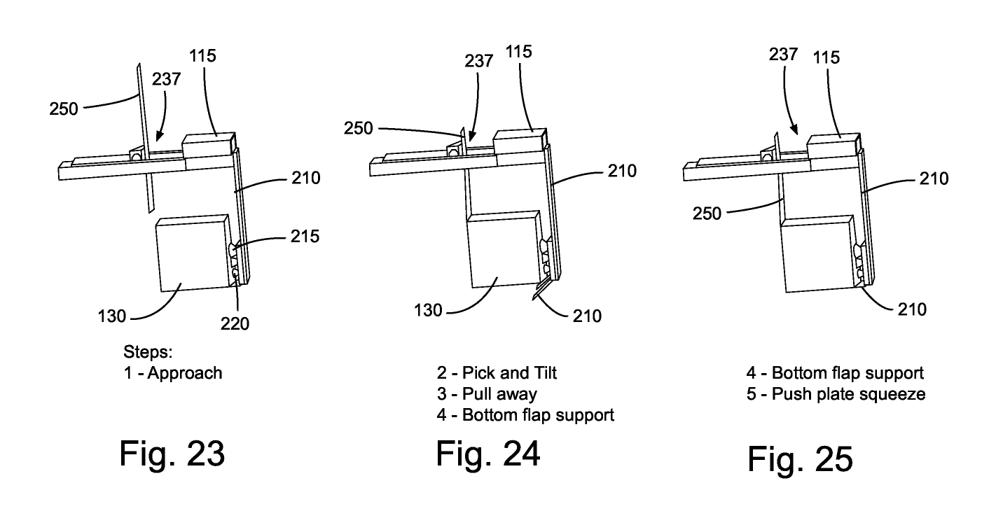

A technique for transferring containers between the Automated Guided Vehicle 105 and the transport structure 125 (or other location) will now be described with reference to FIGS. 1, 2, and 23-25. While the technique will be described with reference to the End of Arm Tool 115 shown in FIG. 2, the End of Arm Tool 300 shown in FIG. 3 and the End of Arm Tool 900 shown in FIG. 9 can also be used in the beverage container handling system 100 in a similar fashion. Moreover, although this technique will be described with reference to beverage containers, the beverage container handling system 100 and this technique can be adapted to handle other types of packaging and in different environments. The End of Arm Tool 115 is designed to mimic how cases are normally picked and packed by an individual. Generally speaking, the End of Arm Tool 115 is designed to approach the “good side” of the containers 130 via a vision system so that the vacuum cups 220 are able to engage the containers 130. The good side is defined by a surface that lacks openings that are able to facilitate vacuum cups 220 being firmly secured to the individual side. Once the vacuum cups 220 of the holding plate 210 contact and establish a vacuum (i.e., low pressure) with one side, the End of Arm Tool 115 pulls out and tilts up the containers 130 away from the stack. The support plate 225 is able to hook underneath the containers 130 so as to provide additional support. For the End of Arm Tool 300 in FIG. 3, the support fingers 325 rotate horizontally to an extended position underneath the containers 130, and with the End of Arm Tool 900 in FIG. 9, the support fingers 925 rotate horizontally to an extended position underneath the containers 130. The push plate 250 that provides high friction on the other end is lowered down and clamps on the end opposite of the vacuum cups 220 and is squeezed against the containers 130 so as to grip the containers 130.

During the picking operation, that is when a beverage carton or one of other containers 130 is being pulled from an already stored pallet 127 of beverages, the Automated Guided Vehicle 105 approaches the stack of beverages such that the robot arm 110 is able via the End of Arm Tool 115 to reach the desired containers 130 or other package. To approach the containers 130, the lift motor 245 via a rack and pinion-type motion raises the push plate 250 so that the push plate 250 is out of the way. The holding plate 210 is then moved towards the appropriate end of the containers 130 that provides sufficient area for the vacuum cups 220 to establish a vacuum. As noted before, the sensor 955 in the form of a vision system is used such as in conjunction with artificial intelligence (AI) networks to determine the best approach for the End of Arm Tool 115. A vacuum is applied to the vacuum cups 220 as the plenum 215 approaches the containers 130. Once the vacuum sensors in the plenum 215 sense the vacuum cups 220 establishing a vacuum with the containers 130 (i.e., low pressure), the robot arm 110 pulls on the End of Arm Tool 115 such that the containers 130 are slightly pulled from the transport structure 125 stack. Afterwards or at the same time, the plenum adjuster 230 raises the plenum 215 slightly via the plenum adjuster 230 such that the containers 130 are tilted. The support plate 225 then is able to grab the edge of the containers 130 facing the holding plate 210. At the same time or shortly thereafter, the lift motor 245 lowers the push plate 250 into position so as to be able to engage the end of the containers 130 that is opposite the holding plate 210 once the push plate 250 that has high-frictional material, such as rubber, synthetic plastic, and the like, is able to squeeze and contact the containers 130 to establish sufficient clamping force to hold the containers 130 in place. In other words the End of Arm Tool 115 is able to squeeze the containers 130 between the push plate 250 and the holding plate 210. Once properly secured, the End of Arm Tool 115 and/or the robot arm 110 is able to remove the containers 130 from the stack and place the containers 130 on the transport structure 125 that is located on the lift mechanism 120 of the Automated Guided Vehicle 105 by generally taking the opposite approach.

Through the vision system, the Automated Guided Vehicle 105 decides where to pack the containers 130 based on the locations of other containers on the transport structure 125. The containers 130 gripped on the End of Arm Tool 115 are moved generally to the appropriate location and slid in a tilted position on top of one or more of the lower containers 130 and/or the transport structure 125. Once the end facing the push plate 250 is supported by the transport structure 125 and/or another one of the containers 130 on the transport structure 125, the gripping force of the push plate 250 is removed and the push plate 250 is raised such that the end of the container is able to be pushed against or propped against other containers 130 on the stack or in the appropriate location. The plenum 215 on the holding plate 210 can then be lowered as the holding plate 210 pushes the containers 130 tightly against the other containers in the appropriate position. At the same time or before then, the support plate 225 can either be folded out of the way in one form or remain in an extended position. The support fingers 325 in the End of Arm Tool 300 of FIG. 3 and the support fingers 925 in the End of Arm Tool 900 of FIG. 9 can be similarly stowed by pivoting horizontally to a stowed position. Once in the proper position, the vacuum can be removed such that the container is released from the holding plate 210 and the End of Arm Tool 115 is moved out of the way via the robot arm 110 so as to pick and/or place other containers 130.

As individual layers of containers are packed on the transport structure 125, the lift mechanism 120 is lowered. The Automated Guided Vehicle 105 can move to the requisite warehouse transport structure 125 of cartons and/or beverages to create the appropriate mixed pallet. As noted before, as the transport structure 125 is loaded, the packing silo 135 helps to further tightly pack the containers on the transport structure 125. Once the transport structure 125 is fully packed, the Automated Guided Vehicle 105 can move to a particular discharge area such that the doors of the chamber can be opened and the transport structure 125 can be discharged via the roller conveyors or conveyor belt located on the lift mechanism 120, via a forklift, and/or in other manners. An empty transport structure 125 can then be loaded back onto the Automated Guided Vehicle 105 and additional mixed transport structure 125 can be built via a similar technique. A generally opposite approach can be taken to restock or replenish pallets at the storage unit 145.

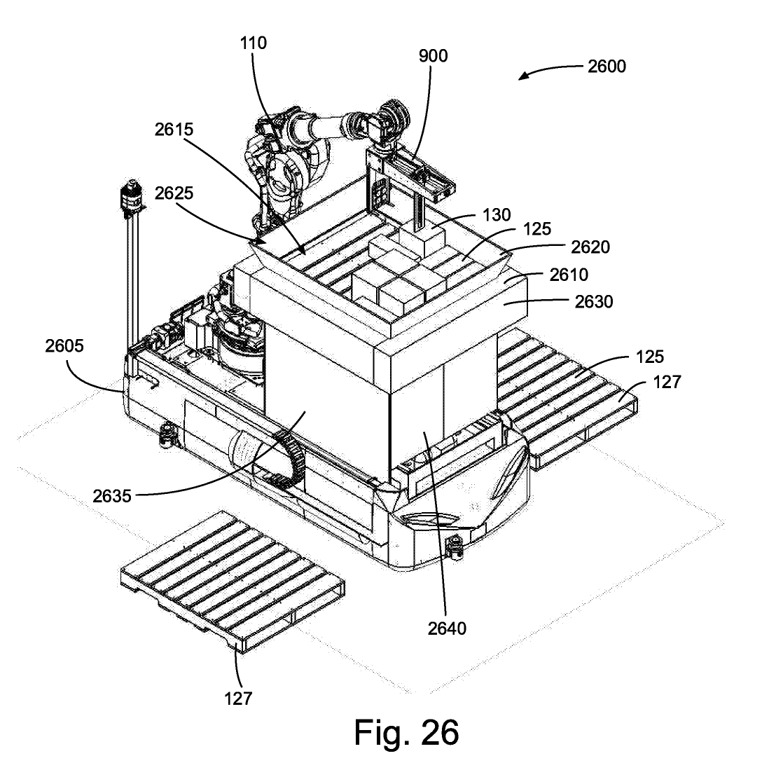

FIGS. 26, 27, and 28 show a beverage container handling system 2600 with an Automated Guided Vehicle 2605 according to another example. As should be recognized, the Automated Guided Vehicle 2605 in FIG. 26 shares a number of features in common with and operates generally in the same fashion as the Automated Guided Vehicle 105 shown in FIG. 1. For the sake of brevity as well as clarity, these common features will not be described in detail again, but please refer to the previous discussion regarding these common features. Like before, the Automated Guided Vehicle 2605 has a robot arm 110, and the robot arm 110 has the End of Arm Tool 900. The Automated Guided Vehicle 105 further includes the lift mechanism 120 for supporting the transport structure 125 which in the depicted example is again the pallet 127. In the illustrated example, the pallet 127 is configured to support the containers 130, such as beverage cartons or water bottle packs. The robot arm 110 is able to transfer containers 130 between the transport structure 125 on the lift mechanism 120 and the transport structure 125 at the storage unit 145 (FIG. 1). Surrounding the lift mechanism 120, the Automated Guided Vehicle 2605 has a packing silo 2610 that slightly differs from the packing silo 135 shown in FIG. 1. The packing silo 2610 defines a packing chamber 2615. The packing chamber 2615 includes a flared section 2620 that surrounds a silo opening 2625 that is proximal to the robot arm 110. The flared section 2620 is similar to a funnel in that the packed containers 130 are compressed together by the flared section 2620 as the transport structure 125 is lowered by the lift mechanism 120. Again, the packing chamber 2615 helps stabilize and tightly pack the containers 130 which is especially helpful for mixed pallets where different shaped and sized beverage cartons as well as other types of packaging (e.g., water bottle trays) are packed. Once more, the packing silo 2610 facing the packing chamber 2615 has a low friction surface to enhance packing. For instance, this inner surface of the packing silo 2610 is formed, coated, or otherwise covered with UHMW material. The packing silo 2610 has a wrapper section 2630 where the packed containers 130 are stretched or shrink wrapped and a discharge section 2635 where the packed pallet 127 is discharged and empty pallets 127 are received. The discharge section 2635 includes one or more doors 2640, such as sliding doors or hinged doors, that open to allow the pallet 127 to be slid off of the lift mechanism 120 through a conveyor.

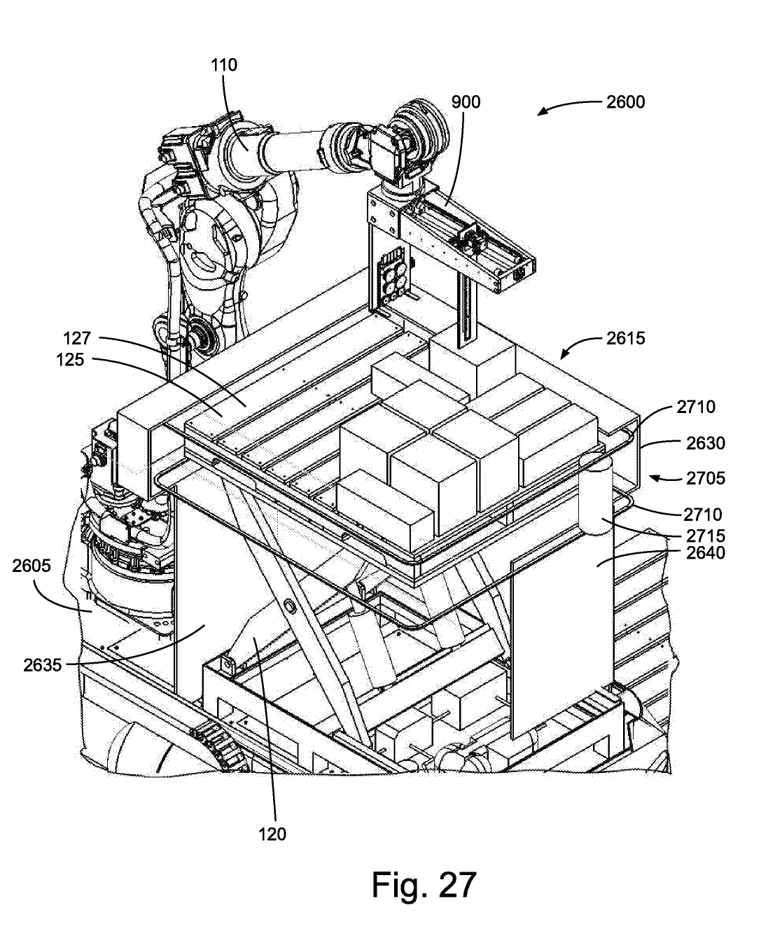

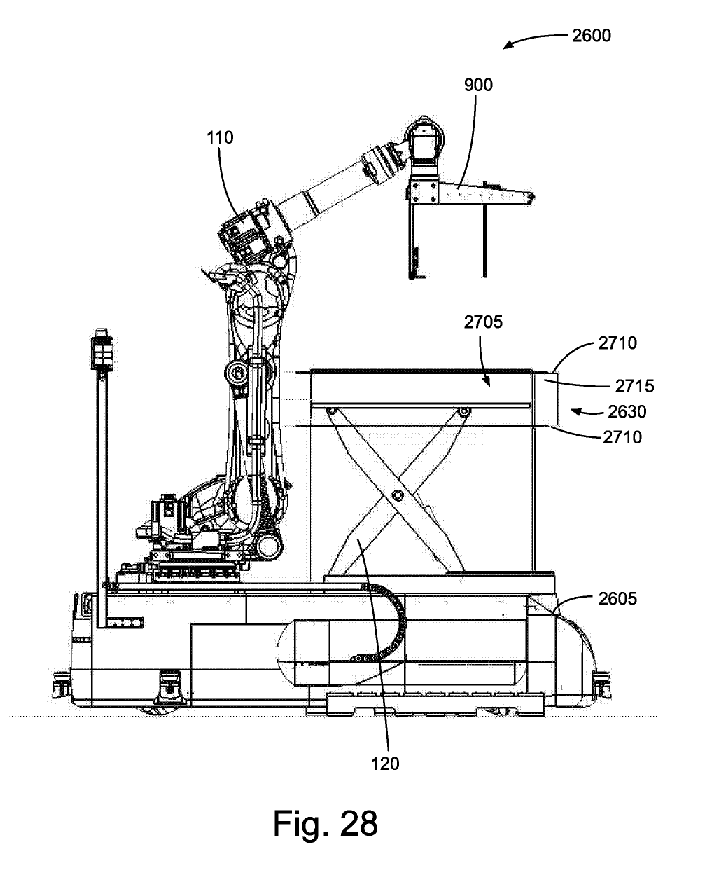

Looking at FIGS. 27 and 28, the wrapper section 2630 of the packing silo 2610 has a stretch wrapper 2705. The stretch wrapper 2705 includes one or more wrapper guide rails 2710 within the wrapper section 2630. As shown, the wrapper guide rails 2710 extend around the packing chamber 2615. The stretch wrapper 2705 further includes one or more rolls 2715 around which wrapping material, such as plastic and/or paper wrap, is rolled. Each roll 2715 wraps the wrapping material around the containers 130 packed on the pallet 127 as the roll 2715 travels along the wrapper guide rails 2710. Once the pallet 127 is fully loaded and wrapped, the doors 2640 are opened and the loaded pallet 127 is discharged.

### Glossary of Terms

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below.

“Automated Guided Vehicle” (AGV) generally refers to a mobile robot that is able to automatically self-navigate between various locations. For example, AGVs are typically, but not always, able to automatically navigate by following markers, such as wires or magnets embedded in the floor, by using lasers, and/or by using one or more vision systems. AGVs are also typically, but not always, designed to automatically avoid collisions, such as with other AGVs, equipment, and personnel. AGVs are commonly, but not always, used in industrial applications to move materials around a manufacturing facility or warehouse.

“Cargo” or “Cargo Items” generally refer to goods or other physical objects that are typically carried or otherwise transported on vehicles, such as on trucks, ships, aircraft, spacecraft, and/or motor vehicles. The cargo items can be unpackaged or packaged, such as in boxes, bags, bales, containers, barrels, and tanks, to name just a few examples.

“Chassis” generally refers to an internal frame and/or supporting structure that supports an external object, body, and/or housing of the vehicle and/or electronic device. In one form, the chassis can further provide protection for internal parts of the vehicle and/or electronic device. By way of non-limiting examples, a chassis can include the underpart of a vehicle, including the frame on which the body is mounted. In an electronic device, the chassis for example includes a frame and/or other internal supporting structure on which one or more circuit boards and/or other electronics are mounted.

“Container” generally refers to an object creating a partially or fully enclosed space that can be used to contain, store, and transport objects, items, and/or materials. In other words, a container can include an object that can be used to hold or transport something. By way of non-limiting examples, containers can include boxes, cartons, plastic packaging, totes, bags, jars, envelopes, barrels, cans, bottles, drums, and/or packages.

“Conveyor” is used in a broad sense to generally refer to a mechanism that is used to transport something, like an item, box, container, and/or SKU. By way of nonlimiting examples, the conveyor can include belt conveyors, wire mesh conveyors, chain conveyors, electric track conveyors, roller conveyors, cross-belt conveyors, vibrating conveyors, and skate wheel conveyors, to name just a few. The conveyor all or in part can be powered or unpowered. For instance, sections of the conveyors can include gravity feed sections.

“End of Arm Tool” (EoAT) or “End Effector” generally refers to a device at the end of the robotic arm that is designed to interact with the environment. The nature of this interaction of the device with the environment depends on the application of the robotic arm. The EoAT can for instance interact with an SKU or other environmental objects in a number of ways. For example, the EoAT can include one or more grippers, such as impactive, ingressive, astrictive, and/or contiguitive type grippers. Grippers typically, but not always, use some type of mechanical force to grip objects. However, other types of interactions, such as those based on suction or magnetic force, can be used to secure the object to the EoAT. By way of non-limiting examples, the EoAT can alternatively or additionally include vacuum cups, electromagnets, Bernoulli grippers, electrostatic grippers, van der Waals grippers, capillary grippers, cryogenic grippers, ultrasonic grippers, and laser grippers, to name just a few.

“Energy Source” generally refers to a device, structure, mechanism, and/or system that provides power for performing work. The energy supplied by the energy source can take many forms including electrical, chemical, electrochemical, nuclear, hydraulic, pneumatic, gravitational, kinetic, and/or potential energy forms. The energy source for instance can include ambient energy sources, such as solar panels, external energy sources, such as from electrical power transmission networks, and/or portable energy sources, such as batteries. The energy source can include an energy carrier containing energy that can be later converted to other forms, such as into mechanical, heat, electrical, and/or chemical forms. Energy carriers can for instance include springs, electrical batteries, capacitors, pressurized air, dammed water, hydrogen, petroleum, coal, wood, and/or natural gas, to name just a few.

“Frame” generally refers to a structure that forms part of an object and gives strength and/or shape to the object.

“Lift Mechanism” or “Lifting Mechanism” generally refers to any mechanical device designed to raise and/or lower objects in a generally vertical direction. By way of non-limiting examples, the lift mechanism can include rotating joints, elevators, screw drives, and/or linkage type devices. The lift mechanism can be designed to discretely lift objects, such as in a case of an elevator, or lift objects in a continuous manner, such as chain and bucket type elevators and/or screw type conveyors. The lift mechanism can be manually and/or automatically powered. For instance, the lift mechanism can be powered by electricity, pneumatics, and/or hydraulics.

“Motor” generally refers to a machine that supplies motive power for a device with moving parts. The motor can include rotor and linear type motors. The motor can be powered in any number of ways, such as via electricity, internal combustion, pneumatics, and/or hydraulic power sources. By way of non-limiting examples, the motor can include a servomotor, a pneumatic motor, a hydraulic motor, a steam engine, pneumatic piston, hydraulic piston, and/or an internal combustion engine.

“Pallet” generally refers to a portable platform or other structure on which goods or items can be assembled, stacked, stored, packaged, handled, transported, and/or moved, such as with the aid of a forklift or pallet jack, as a unit load. Typically, but not always, the pallet is rigid and forms a horizontal base upon which the items rest. Goods, shipping containers, and other items are often placed on a pallet secured with strapping, stretch wrap, and/or shrink wrap. Often, but not always, the pallet is equipped with a superstructure. In one form, the pallet includes structures that support goods in a stable fashion while being lifted by a forklift, pallet jack, front loader, and/or other lifting devices. In particular, pallets typically include a top deck upon which items are stacked, a bottom deck that rests on the ground, and a spacer structure positioned between the top and bottom decks to receive the forks of the forklift or pallet jack. However, the pallets can be configured differently. For example, the term pallet is used in a broader sense to include skids that have no bottom deck. One or more components of the pallet, or even the entire pallet, can be integrally formed together to form a single unit. By way of non-limiting examples, these pallets can include stringer, block, perimeter, skid, solid deck, multiple deck board, panel-deck, slave, double-deck (or face), single-way entry, two-way entry, four-way entry, flush, single-wing, double-wing, expendable, limited-use, multiple-use, returnable, recycled, heat treated, reversible, non-reversible, and/or warehouse type pallets.

“Pinion” generally refers to a relatively small gear in a gear drive train. Typically, but not always, the smaller pinion engages or is engaged inside a larger gear or to a rack. When engaging a rack, rotational motion applied to the pinion causes the rack to move relative to the pinion, thereby translating the rotational motion of the pinion into linear motion. By way of non-limiting examples, the pinion can be incorporated into differential, rack-and-pinion, and clutch bell drive trains, to name just a few. The pinion can be oriented in a number of manners relative to the larger gear or rack. For instance, the pinion can be angled perpendicular to a crown gear in a differential type drive.

“Rack” or “Pinion Rack” generally refers to a generally linear bar that has teeth or is geared. Typically, but not always, the rack engages a gear, such as a pinion.

“Robotic Arm” or “Robot Arm” generally refers to a type of mechanical arm, usually programmable, with similar functions to a human arm. Links of the robot arm are connected by joints allowing either rotational motion (such as in an articulated robot) or translational (linear) displacement. The robot arm can have multiple axes of movement. By way of nonlimiting examples, the robot arm can be a 4, 5, 6, or 7 axis robot arm. Of course, the robot arm can have more or less axes of movement or freedom. Typically, but not always, the end of the robot arm includes a manipulator that is called an “End of Arm Tool” (EoAT) for holding, manipulating, or otherwise interacting with the cargo items or other objects. The EoAT can be configured in many forms besides what is shown and described herein.

“Sensor” generally refers to an object whose purpose is to detect events and/or changes in the environment of the sensor, and then provide a corresponding output. Sensors include transducers that provide various types of output, such as electrical and/or optical signals. By way of nonlimiting examples, the sensors can include pressure sensors, ultrasonic sensors, humidity sensors, gas sensors, motion sensors, acceleration sensors, displacement sensors, force sensors, optical sensors, and/or electromagnetic sensors. In some examples, the sensors include barcode readers, RFID readers, and/or vision systems.

“Stock Keeping Unit” (SKU) or “Item” generally refers to an individual article or thing. The SKU can come in any form and can be packaged or unpackaged. For instance, SKU can be packaged in cases, cartons, bags, drums, containers, bottles, cans, pallets, and/or sacks, to name just a few examples. The SKU is not limited to a particular state of matter such that the item can normally have a solid, liquid, and/or gaseous form for example.

“Storage Unit” or “Storage Shelves” generally refers to a framework structure on which items and/or storage containers are arranged, housed, stored, deposited, and/or removed. The framework can include one or more tiered vertical levels formed by bars, shelves, conveyors, wires, and/or pegs on which the items and/or storage containers are supported. The framework can have different overall shapes. For instance, the framework can have a rectangular or box shape in one example, and in other examples, the framework can include an A-Frame type rack. The location of the levels and rows in the rack can be fixed and/or adjustable.

“Transport structure” generally refers to any type of assembly or device that is able to move items or other objects. A transport structure may be designed to move a single object or may be capable of moving a group of objects. As an example a transport structure may be, but is not limited to, a pallet, skid, container, crate, carton, package, and/or bag.

“Vision System” generally refers to one or more devices that collect data and form one or more images by a computer and/or other electronics to determine an appropriate position and/or to “see” an object. The vision system typically, but not always, includes an imaging-system that incorporates hardware and software to generally emulate functions of an eye, such as for automatic inspection and robotic guidance. In some cases, the vision system can employ one or more video cameras, Analog-to-Digital Conversion (ADC), and Digital Signal Processing (DSP) systems. By way of a non-limiting example, the vision system can include a charge-coupled device for inputting one or more images that are passed onto a processor for image processing. A vision system is generally not limited to just the visible spectrum. Some vision systems image the environment at infrared (IR), visible, ultraviolet (UV), and/or X-ray wavelengths. In some cases, vision systems can interpret three-dimensional surfaces, such as through binocular cameras.

It should be noted that the singular forms “a,” “an,” “the,” and the like as used in the description and/or the claims include the plural forms unless expressly discussed otherwise. For example, if the specification and/or claims refer to “a device” or “the device”, it includes one or more of such devices.

It should be noted that directional terms, such as “up,” “down,” “top,” “bottom,” “lateral,” “longitudinal,” “radial,” “circumferential,” “horizontal,” “vertical,” etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected. All publications, patents, and patent applications cited in this specification are herein incorporated by reference as if each individual publication, patent, or patent application were specifically and individually indicated to be incorporated by reference and set forth in its entirety herein.

Parts List

100 beverage container handling system
105 Automated Guided Vehicle
110 robot arm
115 End of Arm Tool
120 lift mechanism
125 transport structure
127 pallet
130 containers
135 packing silo
140 packing chamber
145 storage unit
205 robot mount
207 plenum and paddle assembly
210 holding plate
215 plenum
220 vacuum cups
225 support plate
230 plenum adjuster
235 frame
237 push plate actuator
240 carriage
245 lift motor
250 push plate
300 End of Arm Tool
305 robot mount
307 plenum and paddle assembly
310 holding plate
315 plenum
320 vacuum cups
325 support fingers
330 plenum adjuster
335 frame
337 push plate actuator
340 carriage
345 lift motor
350 push plate
900 End of Arm Tool
905 robot mount
907 plenum and paddle assembly
910 holding plate
915 plenum
920 vacuum cups
925 support fingers
930 plenum adjuster
935 frame
937 push plate actuator
940 carriage
945 lift motor
950 push plate
955 sensor
1605 plenum adjuster motor
1610 gearbox
1615 drive shaft
1617 drive shaft coupler
1620 guide wheels
1625 guide rails
1630 hinge
1635 finger motors
1640 actuator shaft
1805 vacuum hoses
1810 vacuum ports
1905 vacuum passages
2105 carriage bearings
2110 carriage rails
2115 carriage motor
2120 carriage actuator shaft
2125 carriage shaft coupler
2130 push plate slot
2135 guide bearings
2140 rack
2145 pinion
2600 beverage container handling system
2605 Automated Guided Vehicle
2610 packing silo
2615 packing chamber
2620 flared section
2625 silo opening
2630 wrapper section
2635 discharge section
2640 doors
2705 stretch wrapper
2710 wrapper guide rails
2715 rolls

What is claimed is:

1. A system, comprising:
an end of Arm Tool (EoAT) having at least a first member and a second member;
wherein the first member is configured to lift and pull a container; and
wherein the second member is configured to grab a side of the container opposite the first member.

2. The system of claim 1, wherein the first member of the EoAT has a gripper with a vertically movable vacuum cup plenum.

3. The system of claim 2, wherein the first member has a vacuum cup pattern with large vacuum cups arranged in a triangular pattern and small cups arranged in a line below the large vacuum cups.

4. The system of claim 2, wherein the EoAT has a movable support plate for the gripper.

5. The system of claim 2, wherein the EoAT has one or more foldable gripper fingers configured to grab a corner of the container.

6. The system of claim 2, wherein the EoAT has a plenum adjuster to move the plenum to tilt the container.

7. The system of claim 2, wherein the second member of the EoAT has a push plate and a carriage lift motor configured to vertically move the push plate.

8. The system of claim 7, wherein the carriage lift motor includes a rack and pinion.

9. The system of claim 7, wherein the EoAT includes a carriage that is horizontally moveable to clamp the container with the push plate.

10. The system of claim 1, wherein the EoAT has a robot arm horizontal mount.

11. The system of claim 1, wherein the EoAT has a robot arm side mount.

12. The system of claim 1, further comprising:
an Automated Guided Vehicle (AGV);
wherein the EoAT is mounted to a robot arm; and
wherein the robot arm is mounted to the AGV.

13. The system of claim 12, wherein the AGV has a lift mechanism on which the container is stacked.

14. The system of claim 13, wherein the lift mechanism includes a scissor lift.

15. The system of claim 14, wherein the lift mechanism includes a post screw scissor lift.

16. The system of claim 13, wherein the lift mechanism has a conveyor configured to discharge the container.

17. The system of claim 13, wherein the AGV has a packing chamber.

18. The system of claim 17, wherein the packing chamber has a funnel shape.

19. The system of claim 17, wherein the packing chamber has one or more access doors.

20. The system of claim 17, wherein:
the packing chamber has a chamber opening; and
the AGV has an orbital stretch wrapper located at the chamber opening.

21. The system of claim 17, wherein the robot arm rotates 180 degrees relative to the AGV.

22. The system of claim 1, wherein the EoAT has a pressure plate configured to sense squeezing force.

23. The system of claim 1, wherein the EoAT has a vision system configured to sense gripping of the container.

24. The system of claim 1, wherein the container includes a beverage carton.

25. A method, comprising:
lifting an end of a container from a container stack with an End of Arm Tool (EoAT);
pulling the container by the end with the EoAT; and
grabbing an opposite end of the container with the EoAT.

26. The method of claim 25, wherein said lifting includes moving a vacuum cup plenum of the EoAT in a vertical direction.

27. The method of claim 26, further comprising:
moving a support plate of the EoAT under the container.

28. The method of claim 26, further comprising:
grabbing a corner of the container with one or more foldable gripper fingers of the EoAT.

29. The method of claim 26, wherein said lifting includes tilting the container by moving a plenum adjuster of the EoAT.

30. The method of claim 26, further comprising:
moving a push plate of the EoAT in the vertical direction with a carriage lift motor.

31. The method of claim 30, further comprising:
clamping the container with the push plate by horizontally moving a carriage of the EoAT in a horizontal direction.

32. The method of claim 25, further comprising:
wherein EoAT is mounted to an Automated Guided Vehicle (AGV) via a robot arm; and
transporting the container between the container stack and the AGV with the robot arm.

33. The method of claim 32, further comprising:
stacking the container on a lift mechanism of the AGV; and
moving the container in a vertical direction with the lift mechanism.

34. The method of claim 33, further comprising:
wherein the lift mechanism has a conveyor; and
moving the container with the lift mechanism.

35. The method of claim 33, further comprising:
packing the container in a packing chamber of the AGV with the EoAT.

36. The method of claim 35, further comprising:
stretch wrapping the container in the packing chamber with a orbital stretch wrapper located at an opening of the packing chamber.

37. The method of claim 25, further comprising:
sensing squeezing force on the container with a pressure plate of the EoAT.

38. The method of claim 25, further comprising:
sensing gripping of the container with a vision system of the EoAT.
